(19) United States
(12) Patent Application Publication
(10) Pub. No.: US 2012/0194642 A1
(43) Pub. Date: Aug. 2, 2012

(54) MOTION PICTURE DEPTH INFORMATION PROCESSING SYSTEM AND METHOD

(76) Inventors: WEN-NUNG LIE, CHIA-YI COUNTY (TW); CHUN-YU CHEN, YUNLIN COUNTY (TW)

(21) Appl. No.: 13/019,156

(22) Filed: Feb. 1, 2011

(51) Int. Cl. H04N 13/00

(52) U.S. Cl. 348/43; 348/E13.001

(57) ABSTRACT

A motion picture depth information processing system for processing depth information of a plurality of frames in a motion picture segment, each of which has corresponding color information, is composed of a buffer, a motion estimation unit, a motion compensation unit, and an adaptive post-filtering unit. The system can carry out motion estimation by referring to the color information of the frames to obtain a motion vector for each block in a frame and depth motion compensation based on the aforementioned motion vectors to get an initial depth map for each frame in the segment, then do a post-processing via the adaptive post-filtering unit to get a refined depth map of every frame, and finally generate more definite depth information for the whole motion picture segment, thus reducing geometrical texturing burrs, which are commonly known in the depth processing prior art technology.

### BACKGROUND OF THE INVENTION

1. Field of the Invention

The present invention relates generally to the technology of converting 2D motion pictures into 3D ones, where depth information processing plays a key role, and more particularly, to a motion picture depth information processing system and a motion picture depth information processing method.

2. Description of the Related Art

Over the last few years, 3D display technology has been developed with breakthrough because not only global manufacturers of display panels and/or household appliances have developed 3D displays/televisions one after another but the governments and private enterprises in many countries are aggressively promoting 3D display technology and industries. However, 3D video content is deficient, so the 3D displays/televisions fail to become popular in a short time even though the 3D display hardware technology has approached maturity.

Because the 3D video content is deficient, some of the business owners in the current market researched and developed their own techniques of automatically converting 2D videos to 3D ones. Although such techniques are helpful to converting 2D videos into the 3D video contents, such 3D video contents are either of insufficient depth perception or of erroneous depth estimation to result in uncomfortableness for human eyesight. In other words, the 3D stereoscopic quality resulting from such a kind of automatic conversion techniques cannot allow the viewers to have very good depth perception and comfortableness. Hence, it is still questionable for such techniques to popularize the 3D video contents to the common families.

World Pat. Pub. No. WO2009/013682 A2 disclosed that the depth propagation of a given frame depth map, which is either the depth map of a key frame or a following depth map obtained from the key-frame depth map, can be fulfilled by the modified bilateral filtering and the motion compensation. Essentially, the key-frame depth map can be manually drawn and designated.

Referring to FIG. 4, which is redrawn based on the flow chart of the World Pat. Pub. No. WO2009/013682 A2, under the circumstance that the depth map D^{(t)} of the frame t is available and C^{(t)}, d^{(t+1)} (“C” indicates a color frame, each pixel of which is characterized by R, G and B components; t represents the time index), and D^{(t)} are inputted into the modified bilateral filter to get an initial depth map ID^{(t+1)} of the next frame at t+1. Next, a motion estimation procedure is performed for ID^{(t+1)} to get motion vectors thereof by referring to D^{(t)}. Finally, depth-map motion compensation is applied to the initial depth map ID^{(t+1)} by means of the obtained motion vectors to get a refined depth map D^{(t+1)}. The algorithm of the modified bilateral filtering in the prior art is given as:

$${ID}_{i}^{( t + 1 )} = \frac{{\sum }_{j} {f}_{ij} {w}_{ij}^{( t + 1 , t )} {D}_{j}^{( t )}}{{\sum }_{j} {f}_{ij} {w}_{ij}^{( t + 1 , t )}} \\ {f}_{ij} = \{ \begin{matrix}1 , & if \vert {x}_{i} - {x}_{j} \vert \leq \frac{S - 1}{2} , \vert {y}_{i} - {y}_{j} \vert \leq \frac{S - 1}{2} \\ 0 , & otherwise\end{matrix} \\ {w}_{ij}^{( t + 1 , t )} ≡ {2}^{- α ( \vert {r}_{i}^{( t + 1 )} - {r}_{j}^{( t )} \vert + \vert {g}_{i}^{( t + 1 )} - {g}_{j}^{( t )} \vert + \vert {b}_{i}^{( t + 1 )} - {b}_{j}^{( t )} \vert )} \qquad ( 1 )$$

where i is the pixel in consideration, j is an internal pixel within a regional window centered at pixel i, S is the size of the regional window, (xᵢyᵢ) is the coordinate of the pixel i, fᵢⱼ is the filter mask of the pixel j relative to the pixel i (the mask value of the pixel j within the regional window is 1, and otherwise 0), and wᵢⱼ^{(t+1,t)} is the weight of the pixel j relative to the pixel i. The weight wᵢⱼ^{(t+1,t)} is defined to be a power function of the color difference (e.g, r,g,b values) between pixels i and j; the superscript (t+1,t) merely indicates that the weight is employed for transferring depth information from time t to time t+1; α is a constant for determining the significance of the color difference.

When a key-frame depth map D^{(t)} (t=0) passes through the bilateral filter, in consideration of the color difference between pixels i and j in the color frames C^{(t)} and C^{(t+1)}, respectively, the resulting depth maps following the key frame will present geometrical texturing effect. FIGS. 5(A) & 5(B) show the color frames C^{(t)} and C^{(t+1)} at time t and t+1, respectively. FIG. 5(C) is the depth map D^{(t)} at time t and FIG. 5(D) is the initial depth map ID^{(t+1)} at time t+1 obtained in accordance with the prior art. The geometrical texturing burr generated is marked by the white circle and this defect may adversely affect the accuracy of the following motion estimation to result in inaccuracy of the refined depth map D^{(t+1)} after the initial depth map ID^{(t+1)} passes through the motion estimation and compensation process. Besides, block-based motion estimation in such an approach also makes the refined depth map D^{(t+1)} have a blocking effect, as shown in FIG. 5(E).

In addition to the aforesaid drawbacks, the prior art has more disadvantages. For example, edges in the depth map fail to overlap those in the corresponding color image; the estimated depth values fail to vary accordingly when an object moves forwards/backwards. Particularly, as the process goes on, the quality of the refined depth maps of following frames degrade more and more.

### SUMMARY OF THE INVENTION

The primary objective of the present invention is to provide a motion picture depth information processing system and a motion picture depth information processing method, which can generate 3D video contents of high depth quality.

The foregoing objective of the present invention is attained by the motion picture depth information processing system for processing depth information of a plurality of frames of a motion picture segment in an image processing device, each of the frames having corresponding color information. The system is composed of a buffer, a motion estimation unit, a motion compensation unit, and an adaptive post-filtering unit. The buffer is used to temporarily store a plurality of depth maps after refinement. Each of the refined depth maps corresponds to one of the frames. Each of the frames is composed of a plurality of image blocks, each of which covers a plurality of pixels. Each of the first and the final frames in the motion picture segment is defined as a key frame. The buffer is used to store the refined depth maps for all frames (including the key frames and the non-key frames). The motion estimation unit is to carry out motion estimation of each block in the current frame (forwardly or backwardly starting with the next frame of at least one key frame), taking the previous frame as the reference, according to the color information corresponding to the previous frame and the current frame. The motion compensation unit is to carry out depth motion compensation of the current frame to get an initial depth map of the current frame by referring to the refined depth map of the previous frame according to the motion vector (obtained by the motion estimation unit) corresponding to each block in the current frame. The adaptive post-filtering unit is to define a regional window of a predetermined size which is centered at a reference pixel of the current frame, carry out a weighted sum of the initial depth values corresponding to all of the internal pixels covered within said regional window, and get a refined depth value corresponding to said reference pixel. When the regional window is slidden to center at different reference pixels in the current frame, the refined depth values corresponding to all pixels in the current frame can be obtained. The refined depth values are then united to constitute a refined depth map corresponding to the current frame. The adaptive post-filtering unit then outputs the refined depth map of the current frame to the buffer for temporary storage. The following frames can be processed one by one by means of the motion estimation unit, the motion compensation unit, and the adaptive post-filtering unit to get the refined depth maps for all frames.

The foregoing objective of the present invention is attained by the motion picture depth information processing method having the following steps of (1) acquiring a motion picture segment containing N+1 frames, among which the first frame 0 is defined as the first key frame and the last frame N is defined as the second key frame in the segment. Each of the key frames has a corresponding forward or backward depth map. Each of the N+1 frames is composed of a plurality of blocks, each of which covers a plurality of pixels; (2) carrying out motion estimation of each block in the current frame, taking the previous frame as the reference, according to the color information corresponding to the previous frame and the current frame, to get a motion vector for each block; (3) carrying out depth motion compensation of the current frame to get an initial depth map of the current frame by referring to the refined depth map corresponding to the previous frame according to the motion vectors corresponding to the blocks in the current frame; and (4) defining a regional window of a predetermined size which is centered at a reference pixel of the current frame, carrying out a weighted sum of the initial depth values corresponding to all of the internal pixels covered within the regional window to get a refined depth value corresponding to said reference pixel, and uniting the refined depth values corresponding to all pixels of the current frame to constitute a refined depth map when the regional window is slidden to center at different reference pixels in the current frame.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a first preferred embodiment of the present invention.

FIG. 2(A) is an image frame for comparison.

FIG. 2(B) is a depth map after processing in accordance with the first preferred embodiment of the present invention.

FIG. 2(C) is a depth map after processing in accordance with the prior art.

FIG. 3 is a block diagram of a second preferred embodiment of the present invention.

FIG. 4 is a block diagram of the prior art.

FIG. 5(A) is an image frame for comparison in accordance with the prior art, showing the color information C^{(t)} of a frame t.

FIG. 5(B) is an image frame for comparison in accordance with the prior art, showing the color information C^{(t+1)} a frame t+1.

FIG. 5(C) is a depth map in accordance with the prior art, showing the refined depth map D^{(t)} of the frame t.

FIG. 5(D) is another depth map in accordance with the prior art, showing the refined depth map D^{(t+1)} of the frame t+1.

FIG. 5(E) is another depth map in accordance with the prior art, showing the refined depth map D^{(t+1)} of the frame t+1.

### DETAILED DESCRIPTION OF PREFERRED EMBODIMENTS

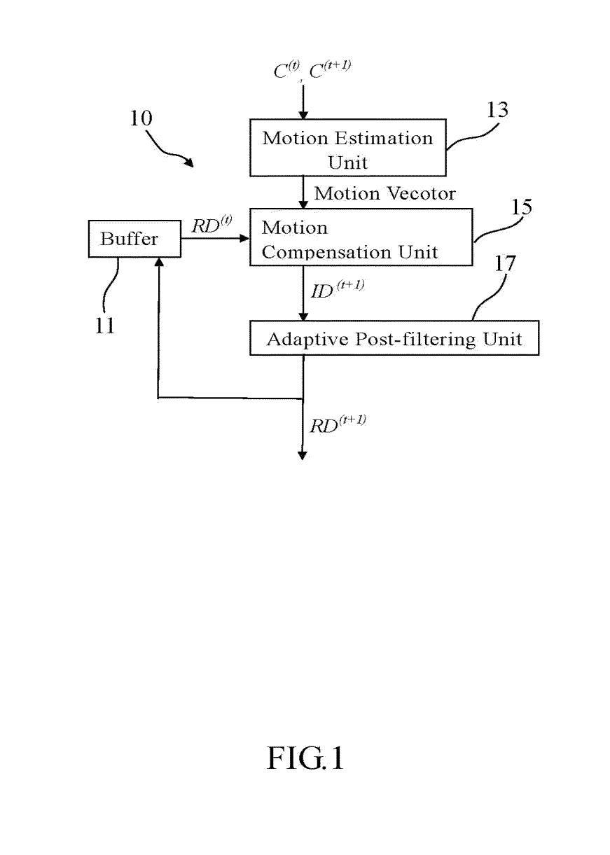

Referring to FIG. 1, a motion picture depth information processing system 10 constructed according to a first preferred embodiment of the present invention for processing depth information of a plurality of frames of a motion picture segment in an image processing device (not shown) is composed of a buffer 11, a motion estimation unit 13, a motion compensation unit 15, and an adaptive post-filtering unit 17. The detailed descriptions and operations of these elements as well as their interrelations are recited in the respective paragraphs as follows.

The motion picture segment is acquired beforehand by partitioning a complete video via a conventional video segmentation technology and includes N+1 frames, among which the frames 0 and N are defined as the first and the last frame in said segment, respectively, and each of which has corresponding color information C^{(t)} t=0, N). Frames 0 and N are two key frames whose depth maps are manually drawn or processed by another hardware or software.

The buffer 11 is provided for temporary storage of a plurality of refined depth maps RD^{(t)} (t=0˜N), among which RD⁽⁰⁾ and RD^{(N)} are for the frame 0 and N, respectively. Each of the N+1 frames defines a plurality of image blocks, each of which covers a plurality of image pixels. The buffer 11 initially includes a refined depth map RD⁽⁰⁾ or RD^{(N)} corresponding to at least one of the key frames in said motion picture segment. In this embodiment, the buffer 11 beforehand includes the refined depth map RD⁽⁰⁾ corresponding to the first key frame.

Mentioning the relationship between the previous frame and the current frame, the previous frame is represented by t and the current frame is represented by t+1.

The motion estimation unit 13 can carry out motion estimation of each block in the current frame, taking the previous frame as the reference, according to the color information C^{(t)} and C^{(t+1)} corresponding to the previous frame and the current frame, respectively, to get a motion vector for each block in the current frame. For the first time, the current frame is the next frame of the first key frame, so the previous frame indicates the first key frame. Because the motion estimation technology belongs to the prior art in the MPEG (Motion Picture Experts Group) video processing field and is not the key point of the present invention, detailed recitation in this regard is skipped.

The motion compensation unit 15 can carry out depth motion compensation of each pixel in the current frame by referring to the refined depth map RD^{(t)} corresponding to the previous frame temporarily saved in the buffer 11 according to the motion vector corresponding to each block in the current frame to get an initial depth value for each pixel and then unite the initial depth values corresponding to all pixels to constitute an initial depth map ID^{(t+1)} corresponding to the current frame. Because the motion compensation technology belongs to the prior art in the MPEG (Motion Picture Experts Group) video processing field and is not the key point of the present invention, detailed recitation in this regard is skipped.

The adaptive post-filtering unit 17 can define a regional window of a predetermined size, which is centered at a reference pixel of the current frame, carry out a weighted sum of the initial depth values corresponding to all of the internal pixels covered within said regional window, and get a refined depth value corresponding to said reference pixel. When the regional window is slidden to center at different reference pixels in the current frame, the refined depth values corresponding to all pixels in the current frame can be obtained. The refined depth values corresponding to all pixels in the current frame are then united to constitute a refined depth map RD^{(t+1)} of the current frame. The adaptive post-filtering unit 17 then outputs the refined depth map RD^{(t+1)} to the buffer 11 for temporary storage. It is to be noted that the weighted sum operation is based on color difference, distance, and difference of the initial depth values between the reference pixel and the internal pixels within the corresponding regional window.

The weighted sum operation done by the adaptive post-filtering unit 17 can be illustrated by the following equation 2. The values, operators, and operation modes in the equation 2 are for illustration only and do not limit the scope of the claim of the present invention.

$${RD}_{i}^{( t + 1 )} = \frac{{\sum }_{j ∈ {Ω}_{i}} {w}_{i , j} \cdot {ID}_{j}^{( t + 1 )}}{{\sum }_{j ∈ {Ω}_{i}} {w}_{i , j}} \\ {w}_{i , j} = \{ \begin{matrix}{2}^{( \frac{Δ I}{0.125} + \frac{Δ d}{0.125} ) ,} & j ∈ {Ω}_{i} \\ 0 , & else\end{matrix} \\ Δ {d}_{i , j} = \vert {ID}_{i}^{( t + 1 )} - {ID}_{j}^{( t + 1 )} \vert \\ Δ {I}_{i , j} = \vert {I}_{i , r}^{( t + 1 )} - {I}_{j , r}^{( t + 1 )} \vert + \vert {I}_{i , g}^{( t + 1 )} - {I}_{j , g}^{( t + 1 )} \vert + \vert {I}_{i , b}^{( t + 1 )} - {I}_{j , b}^{( t + 1 )} \vert \qquad ( 2 )$$

In the equation 2, i is a basic pixel to be filtered and j is an internal pixel within a regional window Ωᵢ centered at i (assuming that Ω is an S×S window); w is a weight coefficient of the pixel j while the pixel i is filtered; Δdᵢⱼ is the depth difference between the pixel j and the pixel i; ΔIᵢⱼ is the color (in terms of, e.g. r,g,b components) difference between the pixel j and the pixel i.

Finally, the motion estimation unit 13, the motion compensation unit 15, and the adaptive post-filtering unit 17 process each of the follow-up frames one by one in turn to get the refined depth map RD^{(t)} of each frame, t=1˜N−1. Then, the depth information processing of the motion picture segment is completed.

The aforesaid system of the first embodiment is to process all of the frames forwardly one by one, starting with the frame 0 and ending with the frame N−1, to further get the refined depth map of each frame RD^{(t)}, t=1˜N−1.

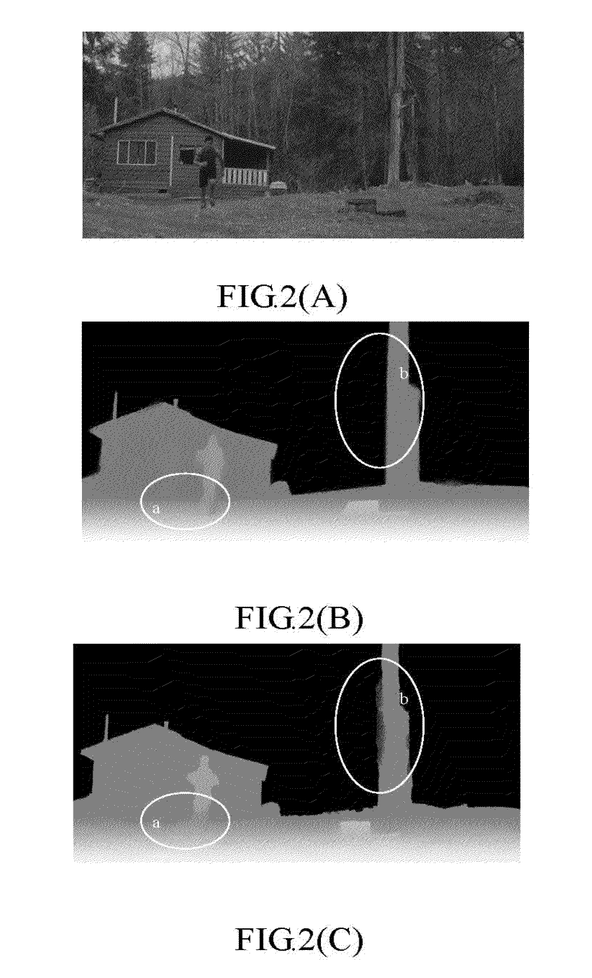

FIG. 2(A) is a representative drawing of the inputted color frame. FIGS. 2(B) and 2(C) are the refined depth maps obtained from the aforementioned depth propagation from the first key frame (frame 0) to the tenth frame in accordance with the system of the first embodiment of the present invention and the conventional method (WO2009/013682 A2) respectively. FIG. 2(C) illustrates that a large number of geometrical texturing burrs marked by a white oval are generated while the tenth frame is processed in accordance with the prior art. FIG. 2(B) shows a frame processed in accordance with the first embodiment of the present invention, demonstrating that the geometrical texturing burrs are greatly reduced.

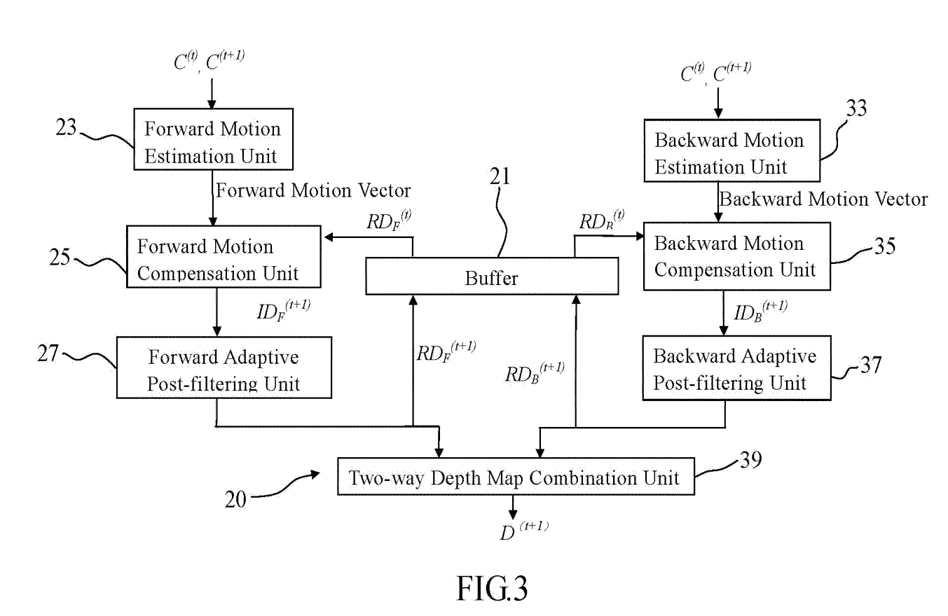

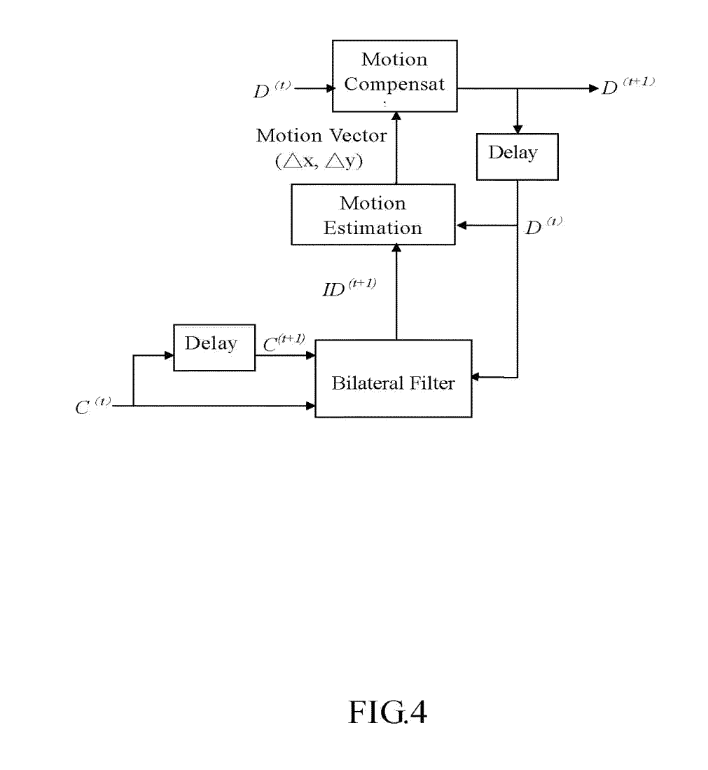

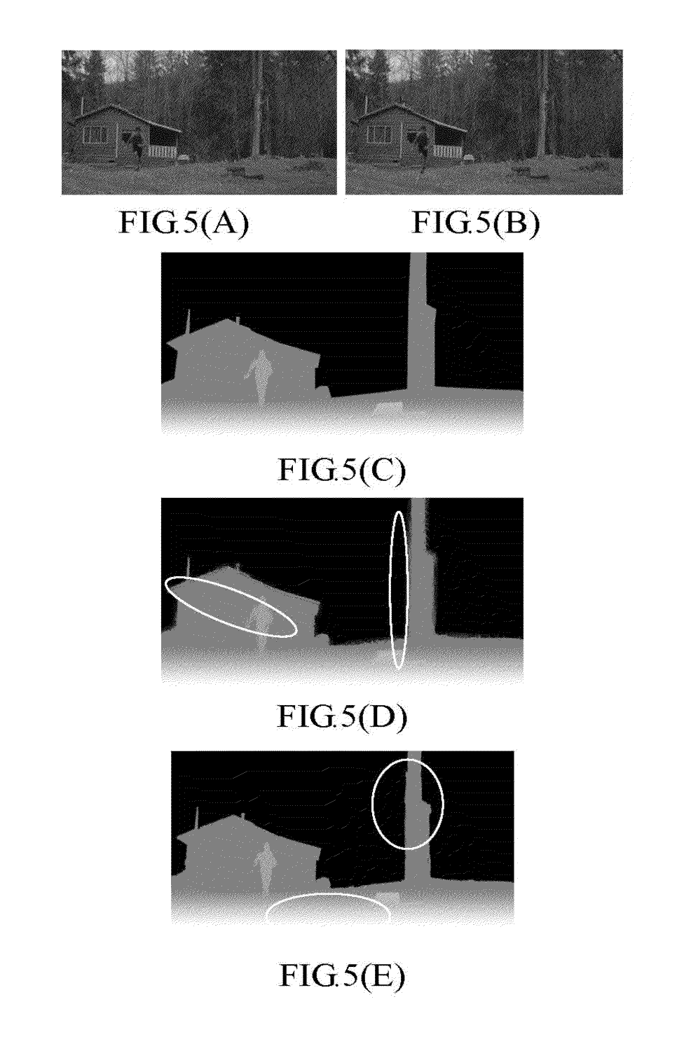

Referring to FIG. 3, a motion picture depth information processing system 20 constructed according to a second preferred embodiment of the present invention for processing depth information of a plurality of frames of a motion picture segment in an image processing device (not shown) is composed of a buffer 21, a forward motion estimation unit 23, a forward motion compensation unit 25, a forward adaptive post-filtering unit 27, a backward motion estimation unit 33, a backward motion compensation unit 35, a backward adaptive post-filtering unit 37, and a two-way depth map combination unit 39. The detailed descriptions and operations of these elements as well as their interrelations are recited in the respective paragraphs as follows.

The buffer 21 can temporarily store a plurality of forwardly refined depth maps RD_{F}^{(t)}(t=0˜N) and a plurality of backwardly refined depth maps RD_{B}^{(t)}(t=0˜N). Each of the forwardly and backwardly refined depth maps RD_{F}^{(t)} and RD_{B}^{(t)} corresponds to one of the frames. Each of the frames defines a plurality of blocks, each of which covers a plurality of pixels. The motion picture segment includes a first frame and a final frame among the frames. Each of the first and the final frame is defined as a key frame. The buffer 21 temporarily keeps the forwardly refined depth map RD_{F}⁽⁰⁾ and the backwardly refined depth map RD_{B}⁽⁰⁾, which correspond to one of the two key frames and the other key frame in said motion picture segment, respectively. Each of the frames includes corresponding color information C^{(t)}(t=0˜N).

The forward motion estimation unit 23 can carry out motion estimation of each block in the current frame, taking the previous frame as the reference, according to the color information C^{(t)} and C^{(t+1)} corresponding to the previous frame and the current frame, respectively, starting with the next frame of the first key frame, to get a forward motion vector of each block in the current frame.

The forward motion compensation unit 25 can carry out depth motion compensation of each pixel in the current frame by referring to the forwardly refined depth map RD_{F}^{(t)} corresponding to the previous frame temporarily saved in the buffer 21 according to the forward motion vector corresponding to each block in the current frame to get a forwardly initial depth value for said each pixel and then unite the forwardly initial depth values corresponding to all pixels to constitute a forwardly initial depth map ID_{F}^{(t+1)} corresponding to the current frame.

The forward adaptive post-filtering unit 27 can define a regional window of a predetermined size, which is centered at a reference pixel of the current frame, carry out a weighted sum of the forwardly initial depth values corresponding to all of the internal pixels covered within said regional window, and get a forwardly refined depth value corresponding to said reference pixel. When the regional window is slidden to center at different reference pixels in the current frame, the forwardly refined depth values corresponding to all pixels in the current frame can be obtained. The forwardly refined depth values are then united to constitute a forwardly refined depth map corresponding to the current frame. The forward adaptive post-filtering unit 27 then outputs the forwardly refined depth map RD_{F}^{(t+1)} to the buffer 21 for temporary storage.

The backward motion estimation unit 33 can carry out motion estimation for all frames one by one in a backward order, starting with the frame N−1 (the second key frame) and ending with the frame 1 (next frame of the first key frame) of the motion picture segment. For better understanding, while the backward motion estimation proceeds, the frames are numbered one by one from the final frame to the first frame; namely, the final frame is now re-numbered to be “t=0”, which is numbered “t=N” in the forward motion estimation, and the first frame is re-numbered to be “t=N”, which is numbered “t=0” in the forward motion estimation. As in the forward motion estimation, the backward motion estimation unit 33 can carry out motion estimation of each block in the current frame (denoted as frame t+1 as in forward motion processing), taking the previous frame t as a reference, according to the color information C^{(t)} and C^{(t+1)} corresponding to the previous frame and the current frame, respectively, to further get a backward motion vector for each block in the current frame.

The backward motion compensation unit 35 can carry out depth motion compensation of each pixel in the current frame by referring to the backwardly refined depth map RD_{B}^{(t)} corresponding to the previous frame temporarily saved in the buffer 21 according to the motion vector corresponding to each block in the current frame to get a backwardly initial depth value for said pixel and then unite the backwardly initial depth values corresponding to all pixels in the current frame to constitute a backwardly initial depth map ID_{B}^{(t+1)} corresponding to the current frame.

The backward adaptive post-filtering unit 37 can define a regional window of a predetermined size, which is centered at a reference pixel in the current frame, carry out a weighted sum of the backwardly initial depth values corresponding to all of the internal pixels covered within said regional window, and get a backwardly refined depth value corresponding to said reference pixel. When the regional window is slidden to center at different reference pixels in the current frame, the backwardly refined depth values corresponding to all pixels in the current frame can be obtained. The backwardly refined depth values are then united by the backward adaptive post-filtering unit 37 to constitute a backwardly refined depth map of the current frame. The backward adaptive post-filtering unit 37 then outputs the backwardly refined depth map RD_{B}^{(t+1)} to the buffer 21 for temporary storage.

The two-way depth map combination unit 39 can combine the forwardly refined depth map RD_{F}^{(t)} and the backwardly refined depth map RD_{B}^{(t)} corresponding to a frame t in the buffer 21 to further bring forth a final depth map D^{(t)} corresponding to said frame t. The way of combination in this embodiment is the weighted sum of both maps as an example. The weight of the combination depends on the propagation distances from the two key frames (frames 0 and N) to the frame t, where the forward propagation distance defines the distance between the frame 0 and the frame t and the backward propagation distance defines the distance between the frame N and the frame t. Namely, as one of the two key frames has a shorter (forward or backward) propagation distance to the frame t, the weight of corresponding forward or backward refined depth map is larger. It is to be noted that the weights can be also fixed coefficients to be irrelevant to the position of the frame t to be processed. The above recitation is for example only but not to limit the scope of the claims of the present invention.

At last, the frames in the motion picture segment are processed one by one in turn via the forward motion estimation unit 23, the forward motion compensation unit 25, the forward adaptive post-filtering unit 27, the backward motion estimation unit 33, the backward motion compensation unit 35, the backward adaptive post-filtering unit 37, and the two-way depth map combination unit 39 to get the final depth maps D^{(t)}, t=1-N−1. Thus, the processing operation of the depth information of the motion picture segment is completed.

Each of the weighted sum operation of the forward adaptive post-processing filter unit 27 and the backward adaptive post-filtering unit 37 is based on the color difference, distance, and difference of the initial depth values between the reference pixel and the internal pixels within a regional window centered there.

The second embodiment is similar to the first embodiment, having the following differences therebetween. In the first embodiment, the processing operation is one-way (forward). In the second embodiment, the processing operation is two-way (forward-backward). The forwardly refined depth map RD_{F}^{(t)} and the backwardly refined depth map RD_{B}^{(t)} got after the processing further pass through the two-way depth map combination unit 39 for combination to generate the final depth map D^{(t)} having more accurate depth values in the second embodiment. Although the two-way processing in the second embodiment needs double operating energy as much as the one-way processing of the first embodiment needs, the frame depth information is more accurate in the second embodiment than in the first embodiment.

The equation 2 set forth in the first embodiment though can also be employed for specifying the processing statuses of the forward adaptive post-processing filter unit 27 and the backward adaptive post-filtering unit 37, but it is identical to that of the first embodiment. In this way, no more recitation of equation 2 is necessary.

A motion picture depth information processing method in accordance with the first and second embodiments of the present invention includes the following steps.

1) Acquire a motion picture segment containing N+1 frames. The frames 0 and N are defined as a first key frame and a second key frame separately, each of which has a corresponding forwardly refined depth map RD_{F}⁽⁰⁾ and a backwardly refined depth map RD_{B}^{(N)}. Each of the frames in the motion picture segment defines a plurality of blocks, each of which covers a plurality of pixels.

2) Carry out motion estimation of each block in the current frame, taking the previous frame as a reference, according to the color information C^{(t)} and C^{(t+1)} corresponding to the previous frame and the current frame, respectively, in a forward or backward or forward-backward order, starting with the next frame of the frame 0, to get a forward motion vector for each block in the current frame, starting with the next frame (in a backward direction) of the frame N to get a backward motion vector for each block in the current frame, or both in the forward-backward order.

3) Carry out depth motion compensation of each pixel in the current frame by referring to the forwardly or backwardly refined depth map RD_{F}^{(t)} or RD_{B}^{(t)} corresponding to the previous frame to get a forwardly or backwardly initial depth value corresponding to each pixel within each block in the current frame.

4) Define a regional window of a predetermined size, which is centered at a reference pixel of the current frame; carry out a weighted sum of the forwardly or backwardly initial depth values corresponding to all of the internal pixels covered within said regional window to get a forwardly or backwardly refined depth value corresponding to said reference pixel; unite the forwardly or backwardly refined depth values corresponding to all of the reference pixels in the current frame to get a forwardly or backwardly refined depth map for the current frame.

If it is intended to proceed with the two-way (forward-backward) processing, the method will include one more step 5 of combining the forwardly refined depth map RD_{F}^{(t)} and the backwardly refined depth map RD_{B}^{(t)} corresponding to a frame t in the buffer 21 to further bring forth a final depth map D^{(t)} corresponding to the frame t. The combination is to apply the weighted sum to the corresponding forwardly refined depth map RD_{F}^{(t)} and the corresponding backwardly refined depth map RD_{B}^{(t)} corresponding to the frame t.

The above steps 1-5 specify the motion picture depth information processing method of the present invention and can be understood in view of the aforesaid first and second embodiments. The effects that the method can attain are identical to those of the second embodiment, so no more description is necessary.

In conclusion, the present invention includes the following advantages and effects.

1. After the motion estimation based on color information of each frame and the depth motion compensation, a further depth-map processing is executed by the adaptive post-filtering unit, such that the problems of geometrical texturing burrs in the prior art can be eliminated significantly.

2. The weighted sum operation of the present invention proceeds is based on the color difference, distance, and difference of the initial depth values between the reference and the neighboring (within a regional window) pixels, which can be regarded as an adaptive trilateral filtering, such that the depth information from such operation is more accurate.

Although the present invention has been described with respect to specific preferred embodiments thereof, it is in no way limited to the specifics of the illustrated structures but changes and modifications may be made within the scope of the appended claims.

What is claimed is:

1. A motion picture depth information processing system for processing depth information of a plurality of frames in a motion picture segment, each of which has corresponding color information, comprising:
a buffer for temporary storage of a plurality of refined depth maps, each of which corresponds to one of the frames, each of the frames defining a plurality of blocks each covering a plurality of pixels, each of the first and final ones of the frames in said motion picture segment defining a key frame, the buffer temporarily having at least one refined depth map corresponding to the key frames;
a motion estimation unit for carrying out motion estimation of each block in the current frame, the previous frame being taken as a reference, according to the color information corresponding to the previous frame and the current frame, the motion estimation starting with the next frame of at least one key frame, to further get a motion vector of each block in the current frame;
a motion compensation unit for carrying out depth motion compensation of pixels in the current frame by referring to the refined depth map corresponding to the previous frame temporarily saved in the buffer according to the motion vector corresponding to each block in the current frame to get an initial depth map corresponding to the current frame; and
an adaptive post-filtering unit for defining a regional window of a predetermined size, which is centered at each reference pixel in the current frame, carrying out a weighted sum of the initial depth values corresponding to all of the internal pixels covered within said regional window to get a refined depth value corresponding to said reference pixel, uniting the refined depth values corresponding to all reference pixels in the current frame to constitute a refined depth map corresponding to the current frame, and outputting the refined depth map of the current frame to the buffer for temporary storage;
whereby following frames are processed one by one by means of the motion estimation unit, the motion compensation unit, and the adaptive post-filtering unit to get the refined depth maps of the frames in the motion picture segment.

2. The motion picture depth information processing system as defined in claim 1, wherein the weighted sum operation of the adaptive post-filtering unit is based on the color difference, distance, and difference of the initial depth values between each reference pixel and the internal pixels within a regional window centered at said reference pixel. 15

3. The motion picture depth information processing system for processing depth information of a plurality of frames in a motion picture segment, each of which has corresponding color information, comprising:
a buffer for temporary storage of a plurality of forwardly refined depth maps and a plurality of backwardly refined depth maps, where each of the forwardly and backwardly refined depth maps corresponds to one of the frames, each of the frames defining a plurality of blocks, each of which covers a plurality of pixels, the motion picture segment having a first frame and a final frame among the frames, each of the first and the final frames defining a key frame, the buffer temporarily keeping the forwardly and backwardly refined depth maps, which correspond to the first frame and the last frame, respectively;
a forward motion estimation unit for carrying out motion estimation of each block in the current frame, the previous frame being taken as a reference, according to the color information corresponding to the previous frame and the current frame separately, the motion estimation starting with the next frame of the first frame, to get a forward motion vector of each block in the current frame;
a forward motion compensation unit for carrying out depth motion compensation of pixels in the current frame by referring to the forwardly refined depth map corresponding to the previous frame temporarily saved in the buffer to get a forwardly initial depth map corresponding to the current frame;
a forward adaptive post-filtering unit for defining a regional window of a predetermined, which is centered at each reference pixel in the current frame, carrying out a weighted sum of the initial depth values corresponding to all of the internal pixels covered within said regional window to get a forwardly refined depth value corresponding to said reference pixel, uniting the forwardly refined depth values corresponding to all reference pixels in the current frame to get a forwardly refined depth map corresponding to the current frame, and outputting the forwardly refined depth map of the current frame to the buffer for temporary storage;
a backward motion estimation unit for carrying out motion estimation of each block in the current frame, the previous frame being taken as a reference, the motion estimation starting with the final frame and ending with the first frame, according to the color information corresponding to the previous frame and the current frame to further get a backward motion vector for each block in the current frame;
a backward motion compensation unit for carrying out depth motion compensation of pixels in the current frame by referring to the backwardly refined depth map corresponding to the previous frame temporarily saved in the buffer to get a backwardly initial depth map corresponding to the current frame;
a backward adaptive post-filtering unit for defining a regional window of a predetermined size, which is centered at each reference pixel in the current frame, carrying out a weighted sum of the backwardly initial depth values corresponding to all of the internal pixels covered within said regional window to get a backwardly refined depth value corresponding to said reference pixel, uniting the backwardly refined depth values corresponding to all reference pixels in the current frame to get a backwardly refined depth map corresponding to the current frame, and outputting the backwardly refined depth map of the current frame to the buffer for temporary storage; and
a two-way depth map combination unit for combining the forwardly and backwardly refined depth maps corresponding to the current frame in the buffer by the way of weighted sum to further bring forth a final depth map corresponding to the current frame;
whereby the following frames are processed one by one in turn by means of the buffer, the forward motion estimation unit, the forward motion compensation unit, the forward adaptive post-filtering unit, the backward motion estimation unit, the backward motion compensation unit, the backward adaptive post-filtering unit, and the two-way depth map combination unit to get the final depth maps corresponding to all the frames in the motion picture segment.

4. The motion picture depth information processing system as defined in claim 3, wherein the weighted sum operations of the forward and the backward adaptive post-filtering units are based on the color difference, distance, and difference of the initial depth values between each reference pixel and the internal pixels within a regional window centered at said reference pixel.

5. The motion picture depth information processing system as defined in claim 3 or 4, wherein the two-way depth map combination unit combines the forwardly and backwardly refined depth maps corresponding to the frame at the same time by the way of weighted sum of the corresponding depth values.

6. A motion picture depth information processing method for processing depth information of a plurality of frames in a motion picture segment in an image processing device, comprising steps of:
1) acquiring a motion picture segment containing N+1 frames, the frames 0 and N being defined as a first key frame and a second key frame, respectively, each of which has one of the corresponding forwardly and backwardly refined depth maps, each of the frames defining a plurality of blocks, each of which covers a plurality of pixels;
2) carrying out motion estimation of each block in the current frame, taking the previous frame as a reference, according to the color information corresponding to the previous frame and the current frame, respectively, in a forward or backward or forward-backward order, starting with the next frame of one of the two key frames, to get a forward or backward motion vector for each block in the current frame;
3) carrying out depth motion compensation of each reference pixel in the current frame by referring to the forwardly or backwardly refined depth map corresponding to the previous frame according to the forward or backward motion vector corresponding to each block in the current frame to get a forwardly or backwardly initial depth value corresponding to each pixel within each block in the current frame; and
4) defining a regional window of a predetermined size, which is centered at a reference pixel of the current frame, carrying out a weighted sum of the forwardly or backwardly initial depth values corresponding to all of the internal pixels covered within said regional window in a forward or backward or forward-backward order to get a forwardly or backwardly refined depth value corresponding to said reference pixel, and uniting the forwardly or backwardly refined depth values corresponding to all of the reference pixels in the current frame to get a forwardly or backwardly refined depth map for the current frame.

7. The motion picture depth information processing method as defined in claim 6, wherein in the step 2), in the forward order, the processing starts with the first frame; in the backward order, the processing starts with the last frame; in the forward-backward order, the processing starts with the first and the final frames individually.

8. The motion picture depth information processing method as defined in claim 7, wherein in the forward-backward order, the method further comprises a step 5) of combining the forwardly refined depth map and the backwardly refined depth map corresponding to the current frame to further bring forth a final depth map corresponding to the current frame.

9. The motion picture depth information processing method as defined in claim 8, wherein the combination in the step 5) is to apply the weighted sum of corresponding depths to the forwardly and backwardly refined depth maps corresponding to the current frame.
